(19) United States
(12) Patent Application Publication
(10) Pub. No.: US 2002/0147995 A1
(43) Pub. Date: Oct. 10, 2002

(54) Method of setting up output format of set-top box

(76) Inventors: Jeong Min Kim, Seoul (KR); Young Mok Kim, Kyonggi-do (KR)

Correspondence Address: BIRCH STEWART KOLASCH & BIRCH, PO BOX 747, FALLS CHURCH, VA, 22040-0747, US

(21) Appl. No.: 10/116,066

(22) Filed: Apr. 5, 2002

(30) Foreign Application Priority Data
Apr. 6, 2001 (KR) P2001-18357

(51) Int. Cl. H04N 7/173; H04N 7/16

(52) U.S. Cl. 725/151; 725/139; 725/131

(57) ABSTRACT

Disclosed is a method of setting up an output format of a set-top box matching an output format of a set-top box identically with that of a display device if the output formats of the set-top box and display device fail to be identical to each other. The present invention includes the steps of setting up preliminarily an output format of the set-top box as one of a plurality of formats the set-top box enables to output, outputting a predetermined message with the preliminary setup output format from the set-top box to a display device connected to the set-top box, informing, if the predetermined message is displayed on the display device, the set-top box of the message display, and fixing the preliminary setup output format to the output format of the set-top box, wherein the output format of the set-top box is made to coincide with an output format of the display device if the output formats of the set-top box and display device are different from each other.

This application claims the benefit of the Korean Application No. P 2001-18357 filed on Apr. 6, 2001, which is hereby incorporated by reference.

### BACKGROUND OF THE INVENTION

1. Field of the Invention

The present invention relates to a digital set-top box providing various output formats, and more particularly, to a method of setting up an output format of a set-top box enabling to set up the output format to be one of the various output format forms.

2. Discussion of the Related Art

Generally, a set-top box itself provides various output formats so as to consider external display devices having different output formats respectively. For instance, the set-top box provides 480i/p(i: interlaced, p: progressive) format for previous analog TV, 720i format considering plasma display panel(PDP), 1080i format for HD ready TV, and the like.

If output formats of a display device to be used and a set-top box fails to match, there occurs no signal or incomplete image on a screen. display device currently used. In order to set up the output format, a user has to manipulate a key attached to a panel of the set-top box. Specifically, for the setup of a general output format, the user repeats to press the key of the set-top box so as to change the output format sequentially to check an image is displayed on the screen of the display device.

Such an output format setup for a general set-top box requires a hardware switch for format transformation so as to increase a product cost of the set-top box as well as annoy the user to manipulate the format transformation switch one by one.

### SUMMARY OF THE INVENTION

Accordingly, the present invention is directed to a method of setting up an output format of a set-top box that substantially obviates one or more problems due to limitations and disadvantages of the related art.

An object of the present invention is to provide a method of setting up an output format of a set-top box matching an output format of a set-top box identically with that of a display device if the output formats of the set-top box and display device fail to be identical to each other.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of setting up an output format of a set-top box according to the present invention includes the steps of setting up preliminarily an output format of the set-top box as one of a plurality of formats the set-top box enables to output, outputting a predetermined message with the preliminary setup output format from the set-top box to a display device connected to the set-top box, informing, if the predetermined message is displayed on the display device, the set-top box of the message display, and fixing the preliminary setup output format to the output format of the set-top box, wherein the output format of the set-top box is made to coincide with an output format of the display device if the output formats of the set-top box and display device are different from each other.

Preferably, the method further includes the step of connecting the set-top box to the display device initially before the preliminary step.

More preferably, the method, after the connecting step, further includes one of the steps of making the set-top box recognize automatically an initial connection between the set-top box and display device and informing the set-top box of the initial connection passively.

More preferably, the method further includes the step of initializing the output format in the set-top box after the recognizing or informing step.

Preferably, the method further includes the step of connecting the display device having the output format different from that of the previously used display device to the set-top box before the preliminary setup step.

More preferably, the method, after the connecting step, further includes one of the steps of making the set-top box recognize a change of the display device recognize automatically and informing the set-top box of the change of the display device passively.

More preferably, the method further includes the step of initializing the output format in the set-top box after the connecting step.

Preferably, the message outputted to the display is an OSD (on screen display) message requesting a user to report the message display.

More preferably, the OSD message provides a menu for reporting the message display to the set-top box.

More preferably, the OSD message further includes a current output format information used by the set-top box.

Preferably, the method further includes the step of outputting the message continuously from the set-top box and standing by for a report of the message display after the message output step.

Preferably, the informing step is carried out by pressing a key established previously at a remote controller.

Preferably, the method further includes the step of changing the preliminary setup output format of the set-top box into one of a plurality of the formats different from the preliminary setup output format if the message display fails to be reported to the set-top box.

More preferably, the changing step is executed automatically after a predetermined time elapses after the output step.

More preferably, the changing step is carried out by pressing a key established previously at a remote controller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a flowchart of a method of setting up an output format of a set-top box according to the present invention;

FIG. 2 illustrates examples of output formats supported by a set-top box preliminary set up in accordance with a method of setting up an output format of a set-top box according to the present invention; and

FIG. 3A and FIG. 3B illustrates examples of messages outputted the moment each output format is set up preliminarily in accordance with a method of setting up an output format of a set-top box according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

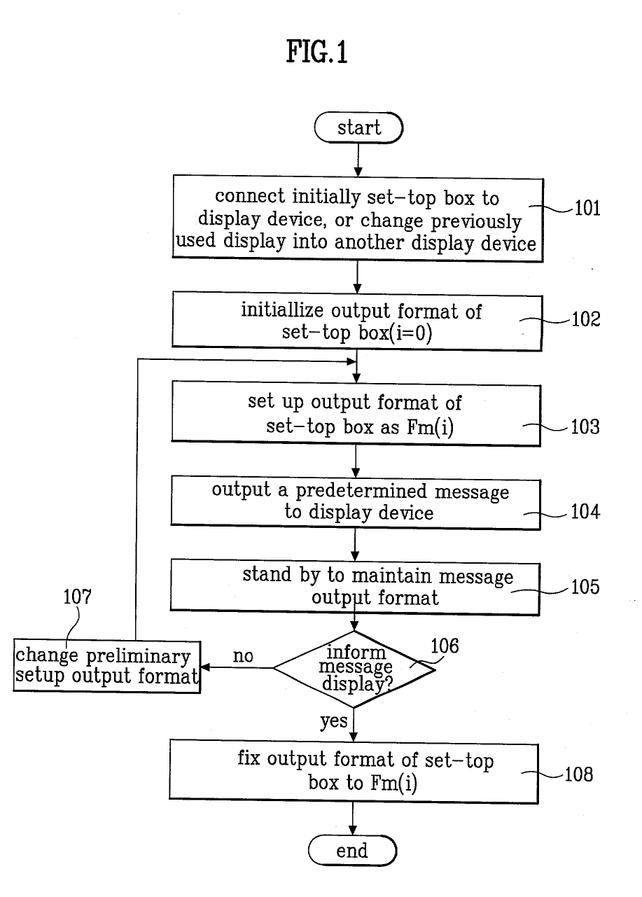

FIG. 1 illustrates a flowchart of a method of setting up an output format of a set-top box according to the present invention.

Referring to FIG. 1, when an output format of a set-top box becomes different that of a display device, the set-top box preliminarily sets up one of a plurality of output-available output formats as its output format (S103).

Before the preliminary setup step S103, the set-top box is initially connected to a display device or the currently used display device is changed into another display device having a different output format (S101). The initial connection between the set-top box and display device, or the change of the display device substantially makes the output format of the set-top box different from that of the display device.

In such a case, the discord in the output formats for the set-top box may be recognized automatically or passively. For convenience's sake of a user, automatic recognition is preferred. Besides, the set-top may be informed of the discord between the output formats box passively by the user, and such an informing step can be carried out by pressing a random specific key (ex. format transform key) established at a remote controller or set-top box.

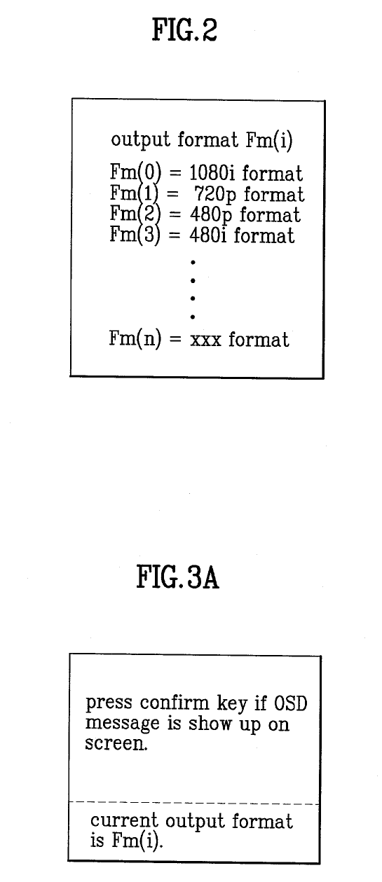

Recognizing the discord between the output formats, the set-top box initializes its output format (S102). When ‘i’ is a variable programmed internally to specify a specific output format in the initialization step S102, the variable i is set up as an initial value, ex. ‘0’. Thereafter, the set-top box sets up substantially the output format as Fm(i) preliminarily (S103). Fm(i) is one of the output formats previously programmed internally in accordance with the variable i in the preliminary setup step (S103), and an example for such an output format Fm(i) is shown in FIG. 2. For instance, if the variable is set up as ‘0’ in the initialization step S102, the output format of the set-top box is preliminarily set up as Fm(0) initially.

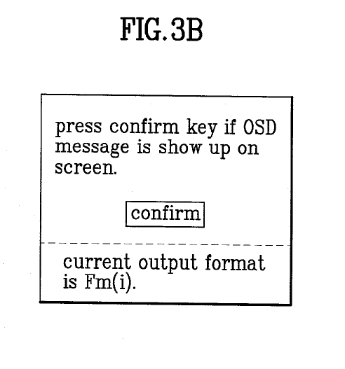

Simultaneously, the set-top box outputs a predetermined message to a display device connected to the set-top box (S104), in which the message is outputted using the output format of the preliminary setup step S103 and substantially becomes an OSD (on screen display) message. The OSD message, as shown in FIG. 3A and FIG. 3B, basically includes a sentence asking to inform the message sign such as “press a confirm key if an OSD message is seen on a screen”. The OSD message, as shown in FIG. 3B, may additionally provide a menu enabling a user to inform the message sign on screen directly. Preferably, the OSD message may further includes the current output format information which is being used by the set-top box. Such output format information, as shown in the drawing, can be expressed as “the current output format is Fm(i)” and plays a role in providing additional information so that the user enables to understand the current output format of the set-top box. Therefore, such an OSD message, when being indicated on the display device, provides sufficient function and information enabling the user to select the output format set up currently.

After the output step S104, if the message is normally displayed on the display device, this means that the output format of the preliminarily established set-top box coincides with that of the display device connected to the set-top box. For instance, if the output format of the display device is 480p and the output format of the set-top box in the preliminary setup step S103 is set up as Fm(2)=480p identical to the output format of the display device, the OSD message that “press a confirm key if an OSD message is seen on the screen. The current output format is 480p.” is normally displayed.

Therefore, the user informs the set-top box of the message display S106. In the informing step S106, the user presses a key set up previously at a remote controller or the like such as a confirm key.

After the output step S104, it is preferable that the set-top box continuously outputs the message as well as stands by for the report of the message display (S105). The standby step S105 provides a spare time enabling the user to check and inform the displayed message.

If the set-top box is informed of the message display successfully through the informing step S106, the set-top box fixes the preliminarily established output format to its output format (S108). Namely, the set-top box receives a previously determined signal from the remote controller or the like, and then uses the preliminarily established output format continuously for an oncoming output of a video signal.

Meanwhile, if the preliminarily established output format of the set-top box fails to coincide with that of the display device, the message is not displayed on the display device. Hence, the user fails to carry out the informing step S106 on the set-top box. Namely, the user is unable to check the message, thereby failing to press the key of the remote controller set up previously according to the request included in the message.

In such a case, the set-top box changes its output format into another one, which is different from the preliminarily established output format, of a plurality of the output formats for the set-top box (S107). In this case, the change step S107 can be carried out by pressing the previously established key (ex. format transform key) of the remote controller. Namely, if the message fails to be displayed after the elapse of a predetermined time, the user enables to execute the change step S107 passively. For convenience' sake of the user, the change step S107 is preferably executed by the set-top box automatically when a predetermined time elapses after the output step S104.

Moreover, the variable i increases, ex. by 1, in the change step S107, and the output format of the set-top box is set up again preliminarily as another output format Fm(i) according to the changed variable i in the preliminary setup step S103. Thereafter, the output and standby steps S104 and S105 are re-executed and the re-execution of the respective steps S103, S104, S105, and S107 is continuously repeated until the informing step S106 is carried out, i.e. the output formats of the set-top box and display device coincide with each other so as to display the message.

On the other hand, the present invention relates to the method of making the output formats of the set-top box and display device. Instead, the present invention can be used for making colors (RGB or YpbPr) of video outputs of the set-top box and display device coincide with each other as well.

Accordingly, in the method of setting up an output format according to the present invention, if the output formats of the set-top box and display device become different from each other, the set-top box self-changes the output-available output formats sequentially so as to output a predetermined message enabling the user to check the accord between the output formats. Therefore, the user enables to set up the output format of the set-top box to coincide with that of the display device conveniently without tedious manipulation. Moreover, a hardware switch for changing the output format of the set-top box passively is unnecessary, thereby enabling to reduce a product cost. The present invention is substantially useful for the cases that the user initially connects the set-top box to the display device and that the user changes the previously used display device into another display device.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A method of setting up an output format of a set-top box, comprising the steps of:
setting up preliminarily an output format of the set-top box as one of a plurality of formats the set-top box enables to output;
outputting a predetermined message with the preliminary setup output format from the set-top box to a display device connected to the set-top box;
informing, if the predetermined message is displayed on the display device, the set-top box of the message display; and
fixing the preliminary setup output format to the output format of the set-top box,
wherein the output format of the set-top box is made to coincide with an output format of the display device if the output formats of the set-top box and display device are different from each other.

2. The method of claim 1, further comprising the step of connecting the set-top box to the display device initially before the preliminary step.

3. The method of claim 2, after the connecting step, further comprising one of the steps of making the set-top box recognize automatically an initial connection between the set-top box and display device and informing the set-top box of the initial connection passively.

4. The method of claim 3, further comprising the step of initializing the output format in the set-top box after the recognizing or informing step.

5. The method of claim 1, further comprising the step of connecting the display device having the output format different from that of the previously used display device to the set-top box before the preliminary setup step.

6. The method of claim 5, after the connecting step, further comprising one of the steps of making the set-top box recognize a change of the display device recognize automatically and informing the set-top box of the change of the display device passively.

7. The method of claim 6, further comprising the step of initializing the output format in the set-top box after the connecting step.

8. The method of claim 1, wherein the message outputted to the display is an OSD (on screen display) message requesting a user to report the message display.

9. The method of claim 8, wherein the OSD message provides a menu for reporting the message display to the set-top box.

10. The method of claim 8, wherein the OSD message further includes a current output format information used by the set-top box.

11. The method of claim 1, further comprising the step of outputting the message continuously from the set-top box and standing by for a report of the message display after the message output step.

12. The method of claim 1, wherein the informing step is carried out by pressing a key established previously at a remote controller.

13. The method of claim 1, further comprising the step of changing the preliminary setup output format of the set-top box into one of a plurality of the formats different from the preliminary setup output format if the message display fails to be reported to the set-top box.

14. The method of claim 13, wherein the changing step is executed automatically after a predetermined time elapses after the output step.

15. The method of claim 13, wherein the changing step is carried out by pressing a key established previously at a remote controller.
